(19) United States
(12) Patent Application Publication
(10) Pub. No.: US 2023/0334507 A1
(43) Pub. Date: Oct. 19, 2023

(54) ELECTRIC TRACTOR TOTAL COST OF OWNERSHIP ANALYSIS

(71) Applicant: SOLECTRAC, INC., Albion, CA (US)

(72) Inventor: Stephen Heckeroth, Albion, CA (US)

(21) Appl. No.: 17/722,913

(22) Filed: Apr. 18, 2022

(51) Int. Cl. G06Q 30/00; G06Q 50/02; H04L 9/00

(52) U.S. Cl. CPC G06Q 30/018; G06Q 50/02; H04L 9/50

(57) ABSTRACT

One or more operation records related to an operation of a fleet of one or more electric tractors by an agriculture business on a particular land area may be stored in a chained operation record ledger. A certification authority may be provided with access to the chained operation record ledger for the certification authority to determine based at least on data in the chained operation record ledger whether the agriculture business meets one or more certification requirements of a certification status. In response to the certification authority determining that the agriculture business has met one or more certification requirements of the certification status, a notification indicating that the agriculture business has achieved the certification status is provided for presentation on a user device of the agriculture business. Otherwise, another indication that the agriculture business has failed to achieve the certification status is provided for presentation on the user device.

### BACKGROUND

It has been estimated that there are approximately 25 million tractors in the world as of 2020, and the number of tractors has historically doubled about every 20 years. This means that the worldwide number of tractors is likely to reach over 50 million by 2040. Farmers in rich agricultural exporting countries predominately have large-size farms and use fossil fuel-powered tractors with up to 600 horsepower. These tractors may consume 30 or more gallons of diesel fuel per hour. Further, all fossil fuel-powered tractors produce CO₂ emissions and other environmental pollutants. Accordingly, there is a growing interest in many farming communities with respect to the use of electric tractors for sustainable farming practices that are more environmentally friendly. However, although electric tractors have many environmental benefits, it may be difficult for some farmers to understand the economic costs or benefits associated with switching from fossil fuel-powered tractors to electric tractors. Such lack of understanding may contribute to the reluctance on the part of some farmers to switch from using fossil fuel-powered tractors to using electric tractors.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture of an electric tractor total cost of ownership (TOC) analysis platform that provides electric tractor TOC record keeping and analysis.

FIG. 2 is a block diagram showing various components of one or more illustrative computing nodes that enable the use of the TOC analysis platform that provides electric TOC recording keeping and analysis.

FIG. 3 is a flow diagram of an example process for appending an electric tractor operation record to a TOC chained operation record ledger.

FIG. 4 is a flow diagram of an example process for obtaining a certification status from a certification authority for an agriculture business based on data in the TOC chained operation record ledger.

FIG. 5 is a flow diagram of an example process for comparing a total operational expense for a fleet of one or more electric tractors operated by an agriculture business to an operational expense for a comparable fleet of one or more fossil fuel tractors.

FIG. 6 is a flow diagram of an alternative example process for comparing a total operational expense for a fleet of one or more electric tractors operated by an agriculture business to an operational expense for a comparable fleet of one or more fossil fuel tractors.

FIG. 7 is a flow diagram of an example process for estimating an amount of initial capital expenditure for converting an agriculture business from using a fleet of one or more fossil fuel tractors to using a fleet of electric tractors.

### DETAILED DESCRIPTION

This disclosure is directed to techniques that use a chained operation record ledger to store the operation records related to the operation of a fleet of one or more electric tractors by an agriculture business. The electric tractors are farming vehicles used for agriculture work, in which the electric tractors are powered by electric motors instead of internal combustion engines and equipped with on-board batteries for supplying electrical power to the electric motors. The electric tractors may have various wheeled and/or tracked configurations for mobility across fields and other terrains, in which the electric tractors may be fitted with various electrically powered farming tool attachments and accessories. The agriculture business may be a farm or several related farms that are engaged in the commercial cultivation of crops. The chained operation record ledger may be a blockchain ledger or a comparable distributed ledger. Alternatively, the chained operation record ledger may be a non-distributed standalone ledger. Nevertheless, each type of ledger is configured to securely store information in a way that prevents tampering or modification of the information stored in the ledger subsequent to the storage of the information in the ledger. The operation records may be used to track the expenses and credits that are related to the operation of the fleet of one or more electric tractors. The expenses may include equipment purchase costs, electricity costs, vehicle maintenance costs, labor costs, insurance costs, health and safety costs, and/or so forth. For example, the equipment may include one or more electric tractors, tools, and accessories (e.g., power-takeoff (PTO) tools and accessories) for the one or more electric tractors, support equipment (e.g., electrical charging stations, battery chargers, swappable electrical batteries, etc.), electricity generation equipment (e.g., solar panels, wind turbines, etc.), and/or so forth.

The credits may include governmental and/or private credits that can be used to offset the costs associated with using the fleet of electric tractors. The credits may include one-time or ongoing government and/or private subsidies and grants that are offered to agricultural operations that partially or exclusively use electric tractors. For example, the credits may include grants or subsidy payments for purchasing electrically power farm equipment, grant or subsidy payments for reducing CO₂ emission, grant or subsidy payments related to the use of environmentally friendly or sustainable agricultural practices, grant or subsidy payment for the installation of electrical charging and/or power generation equipment, and/or so forth. Accordingly, the data that is tracked in the operation records may be used by an electric tractor total cost of ownership (TOC) analysis platform to demonstrate the agriculture business that uses the fleet of one or more electric tractors meets one or more certification statuses set by various certification authorities, such as governmental agencies or private organizations. In some instances, the ability of the agriculture business to receive or continue to receive subsidies, grants, and/or business may be contingent upon the agriculture business attaining and/or maintaining one or more particular certificate statuses.

In other embodiments, the TOC analysis platform may perform financial analysis of the expenditure that is tracked in the operation records of the chained operation record ledger. For example, the expenditure that is tracked in the operation records may be analyzed and compared with the expenditure associated with running a comparable agriculture business using a fleet of fossil fuel tractors. In this way, the TOC analysis platform may show the economic benefit of using the fleet of electric tractors instead of a comparable fleet of fossil fuel tractors. In further embodiments, the TOC analysis platform may be further configured to compare the expenses associated with operating a fleet of electric tractors to expenses associated with operating a fleet of fossil fuel tractors for the purpose of calculating an initial expense associated with the converting the fleet of electric tractors.

By using a chained operation record ledger to store the operation records of an agriculture business that uses electric tractors, the agriculture business may demonstrate with nearly irrefutable proof that the agriculture business complies with various environmentally farming practices. Further, the operation records stored in the chained operation record ledger may be used to show that the agriculture business derives economic benefits from the use of electric tractors over the use of comparable fossil fuel tractors. The techniques described herein may be implemented in a number of ways. Example implementations are provided below with reference to the following figures.

### Example Architecture

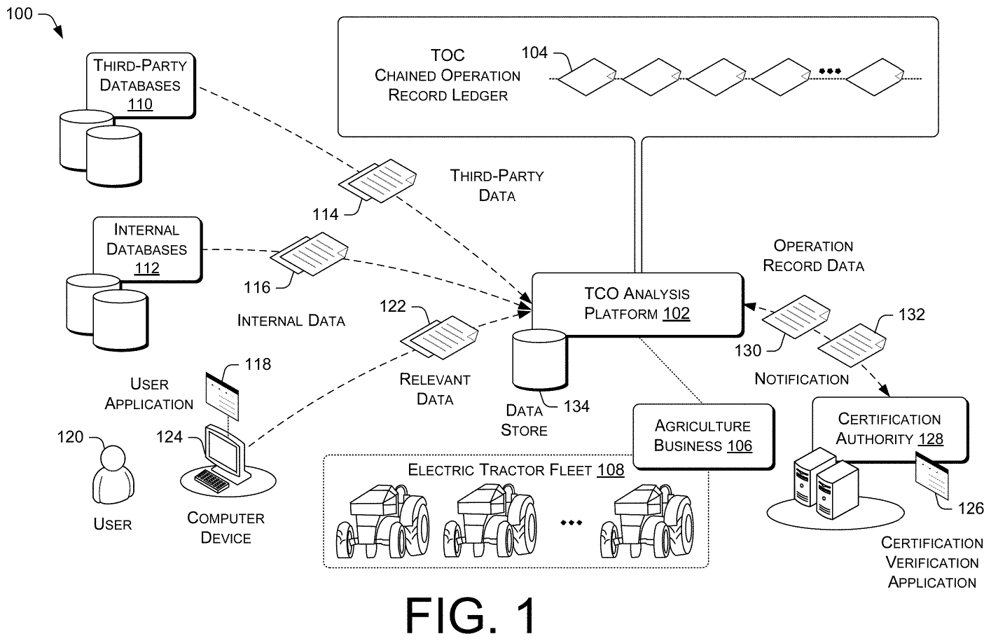

FIG. 1 illustrates an example architecture 100 of a TOC analysis platform that provides electric tractor TOC record keeping and analysis. The TOC analysis platform 102 may be an application that is executed by one or more computing devices. The TOC analysis platform 102 may use a TOC chained operation record ledger 104 to track the operation records associated with an agriculture business 106 that uses a fleet 108 of one or more electric tractors. The agriculture business 106 may be a farm or several related farms that are engaged in the commercial cultivation of crops. The TOC chained operation record ledger 104 may be a blockchain ledger, a comparable distributed ledger, or a non-distributed standalone ledger. For example, the non-distributed standalone ledger may be a ledger that is not simultaneously stored on multiple data storage nodes maintained by multiple third parties. Rather, the non-distributed standalone ledger may be a ledger that is stored in a data storage node that is under the control of a party that operates the TOC analysis platform 102. Each type of ledger is configured to securely store information in a way that prevents tampering or modification of the information stored in the ledger subsequent to the storage of the information in the ledger.

The operation records may be used to track the expenses and credits that are related to the operation of the fleet of one or more electric tractors. The expenses may include equipment purchase costs, electricity costs, vehicle maintenance costs, labor costs, insurance costs, health and safety costs, and/or so forth. For example, the equipment may include one or more electric tractors, tools, and accessories (e.g., power-takeoff (PTO) tools and accessories) for the one or more electric tractors, support equipment (e.g., electrical charging stations, battery chargers, swappable electrical batteries, etc.), electricity generation equipment (e.g., solar panels, wind turbines, etc.), and/or so forth.

The credits may include governmental and/or private credits that can be used to offset the costs associated with using the fleet of one or more electric tractors. The credits may include one-time or ongoing government and/or private subsidies and grants that are offered to agricultural operations that partially or exclusively use electric tractors. For example, the credits may include grants or subsidy payments for purchasing electrically powered farm equipment, grant or subsidy payments for reducing CO₂ emission, grant or subsidy payments related to the use of environmentally friendly or sustainable agricultural practices, grant or subsidy payments for the installation of electrical charging and/or power generation equipment, and/or so forth. As an example, the amounts of grants or subsidy payments may be calculated by a corresponding government agency or private organization based on modeled reduction in activities such as pumping of fossil fuel, mining of fossil fuel, refining of fossil fuel, distribution of fossil fuel, and/or so forth. Alternatively, or concurrently, the calculation may be performed based on modeled reduction in air pollution, greenhouse gas (GHG) gas emission from fossil fuel, related contamination of water and/or soil, and/or so forth. In such an example, the modeled reduction and calculated amounts of grants or subsidy payments may be based on (e.g., in proportion to) factors and/or values related to the fossil fuel tractors that are replaced with electric tractors. Such factors and/or values may include the number, the type, the fossil fuel consumption rate, the amount of operation time during specified time intervals, and/or so forth.

The data that is stored in the operation records of the TOC chained operation record ledger 104 may come from multiple sources, such as third-party databases 110, internal databases 112, and a user application 118. The third-party databases 110 may include databases that are maintained by third-party governmental entities and private organizations. For example, the third-party databases 110 may store information regarding one-time and/or recurring payments of grants or subsidy payments made to the agriculture business 106. For example, the payments may be made to the agriculture business 106 for operating a fleet of one or more electric tractors, generating electricity onsite using alternative energy sources (e.g., solar, wind, etc.), sequestering carbon into the soil, and/or so forth. In another example, the third-party databases 110 may store information regarding one-time taxes and/or fees that are paid by the agriculture business 106. The fees may include government regulatory fees, such as permit fees, licensing fees, environmental fees, and/or so forth that are paid by the agriculture business 106.

The internal databases 112 may include databases that are maintained by the agriculture business 106 to track information related to the operations of the agriculture business 106. For example, the information may include one-time and/or recurring expenses, such as equipment purchase costs, electricity costs, vehicle maintenance costs, labor costs, insurance costs, health and safety costs, and/or so forth associated with using the fleet of electric tractors. The internal databases 112 may include databases that are maintained by various software applications that are used by the agriculture business 106, such as an accounting application, a payroll application, a maintenance tracking application that monitors the cost of maintaining and repairing a fleet of electric tractors, an operation tracking application that tracks the operational history for the fleet of electric tractors, a tax application, an inventory application, a utility (e.g., electricity) usage monitoring application, and/or so forth. These applications may be executed by one or more computing devices operated by the agriculture business 106. These computing devices are able to exchange communication with the TOC analysis platform 102 via a network connection, such as the Internet. In some embodiments, the internal databases 112 may also include databases that are maintained by the electric tractors. Such databases may include databases that are used by engine control units (ECUs), vehicle control units (VCUs), on-board diagnostic applications, on-board health status applications, and/or other on-board software of the electric tractors. In such embodiments, the software on the electric tractors may use communication interfaces (e.g., communication software and hardware) to exchange data with the computing devices operated by the agriculture business 106 via short-range communication (e.g., Wi-Fi, Bluetooth, etc.) or long-range communication (e.g., cellular, satellite, etc.). Accordingly, the TOC analysis platform 102 may use various data push or data pull mechanisms to periodically retrieve data from the third-party databases 110 and the internal databases 112 via a network. The network may be a local area network (LAN), a wide area network (WAN), the Internet, and/or some other network. For example, the TOC analysis platform 102 may receive third-party data 114 from the third-party databases 110 and internal data 116 from the internal databases 112. In turn, the TOC analysis platform 102 may convert the retrieved data into operation records for storage in the TOC chained operation record ledger 104.

The user application 118 may be used by a user 120 to input additional data 122 for storage as operation records in the TOC chained operation record ledger 104. The additional data 122 may be a last-minute or supplemental expenditure or credit information that is not otherwise obtainable from the third-party databases 110 and the internal databases 112. For example, the information may include an amount of a recent grant that is received from a government entity or an amount of an unexpected expense due to a mechanical malfunction of a tractor. The user application 118 may be a web browser or a resident application that executes on a computing device 124. For example, the user 120 may use the user application 118 to submit user authentication credentials (e.g., login, password, biometric information, etc.) to the TOC analysis platform 102. Following the validation of the user authentication credentials by the TOC analysis platform 102, the platform may permit the user 120 to use the user application 118 to input the relevant information. In order to facilitate the entry of information, the TOC analysis platform 102 may provide the user application 118 with predefine data forms that include selectable menu categories or options that may be used by the user 120 to submit information.

In some embodiments, the TOC analysis platform 102 may be further configured to enable the user 120 to select the specific databases that the TOC analysis platform 102 may retrieve data from for inclusion as operation records, the frequency of the data retrievals, and/or so forth via the user application 118. In other embodiments, the TOC analysis platform 102 may also enable the user 120 to access the operation records via the user application 118. For example, the user application 118 may be used to view modify, or delete, operation records before they are stored in the TOC chained operation record ledger 104. In another example, the user application 118 may be used to view operation records that are previously stored in the TOC chained operation record ledger 104.

The data that is tracked in the TOC chained operation record ledger 104 may be used to obtain one or more certification statuses set by various certification authorities, such as governmental agencies or private organizations. In some instances, the ability of the agriculture business to receive or continue to receive subsidies, grants, and/or business may be contingent upon the agriculture business attaining and/or maintaining one or more particular certificate statuses. For example, a government agency may provide a subsidy to an agriculture business that uses electric tractors for at least a predetermined percentage of agriculture operations performed by the agriculture business during a particular time period. In another example, a utility company may offer money to buyback excess electricity that are sustainably generated on-site by the agriculture business when such electricity is not used to power the electric tractors. In an additional example, another business may be committed to purchasing agricultural products from the agriculture business so long as the agricultural business is certified as having reduced or zero carbon emission by an independent private certification organization. In other words, the obtainment of a certification status by the agriculture business 106 from a government agency or a private organization may be a prerequisite for receiving a subsidy, a grant, or a business purchase from a government entity or a private business. Thus, in some embodiments, the TOC analysis platform 102 may provide a certification verification application 126 of a certification authority 128 with access to the TOC chained operation record ledger 104. For example, the TOC analysis platform 102 may provide the certification verification application 126 with access to application program interfaces (APIs) that can be called by the certification verification application 126. Such APIs may be APIs provided by the TOC analysis platform 102, or APIs that are provided by a third-party distributed ledger service application used by the TOC analysis platform 102. In turn, the certification verification application 126 may call the APIs to access the data in the operation records. The certification verification application 126 may interact with the TOC analysis platform 102 to access the TOC chained operation record ledger 104 via a network.

In some instances, the certification verification application 126 may use pre-programmed logics to automatically review the operation record data 130 in the operation records. For example, the certification verification application 126 may review an operational log data stored in the operation records for the fleet of electric tractors. As such, the certification verification application 126 may verify that the electric tractors were used to perform work for at least a predetermined number of hours in a given time interval as required by a certification status. In another example, the certification verification application 126 may review the operation log data and utility usage log data stored in the operation records and determine that the amount of electricity sustainably generated on-site to power a fleet of electric tractors meets a predetermined percentage threshold required by a certification status. Accordingly, the certification verification application 126 may automatically provide a notification 132 of certification status fulfillment or failure to the TOC analysis platform 102. In other instances, the certification verification application 126 may provide the operation record data 130 for manual review by an administrator of the certification authority. Following the review, the administrator may use an application user interface of the certification verification application 126 to initiate the notification 132 of certification status fulfillment or failure. In some instances, in the case of notification 132 of certification status fulfillment, the certification verification application 126 may also trigger the distribution of grants or subsidies to an account of the agriculture business 106.

The TOC analysis platform 102 may further store historical TOC information in a data store 134. The historical TOC information may include operation records related to the use of fossil fuel tractors by the agriculture business 106. The historical TOC information may be obtained from multiple sources. The multiple sources may include third-party databases of government agencies or private organizations that transact business with or regulate the agriculture business 106, internal databases maintained by the agriculture business 106, as well information that is inputted via the user application 118. For example, the information may include one-time and/or recurring expenses, such as equipment purchase costs, electricity costs, vehicle maintenance costs, labor costs, insurance costs, health and safety costs, and/or so forth associated with using the fleet of fossil fuel tractors. The various databases may include databases that are maintained by various applications. Such applications may include an accounting application, a payroll application, a maintenance tracking application that monitors the cost of maintaining and repairing a fleet of fossil fuel tractors, an operation tracking application that tracks the operational history for the fleet of fossil fuel tractors, a tax application, an inventory application, a utility (e.g., electricity, fossil fuel) usage monitoring application, and/or so forth.

In this way, the TOC analysis platform 102 may use the data stored in the TOC chained operation record ledger 104 and the data store 134 to perform financial analysis that compares the costs of using electric tractors versus fossil fuel tractors. For example, the expenditure associated with using a fleet of electric tractors may be analyzed and compared with the expenditure associated with using a fleet of fossil fuel tractors for comparably sized plots of land for similar time periods. In this way, the TOC analysis platform 102 may show the economic benefit of using the fleet of electric tractors instead of a comparable fleet of fossil fuel tractors. In further embodiments, the TOC analysis platform 102 may be further configured to compare the expenses associated with operating a fleet of electric tractors to expenses associated with operating a fleet of fossil fuel tractors for the purpose of calculating an initial expense associated with converting the fleet of electric tractors. In some embodiments, the TOC analysis platform 102 may have the ability to use machine-learning algorithms to estimate the costs and credits associated with operating a fleet of electric tractors over an extended period of time for comparison with the expenses of operating a fleet of fossil fuel tractors.

In some alternative embodiments, the operation records associated with operating a fleet of electric tractors may be stored in the data store 134 instead of stored as the TOC chained operation record ledger 104. For example, when there is a lack of need to provide operation records in a secured tamper-resistant format for review by third-party certification authorities, the storage of such operation records in the data store 134 may provide additional computation resource usage efficiency.

Furthermore, while the TOC analysis platform 102 is illustrated in FIG. 1 as providing services to a single agriculture business 106, the TOC analysis platform 102 may be operated as an independent platform that provides similar services to multiple agriculture businesses in other embodiments. In such embodiments, the TOC analysis platform 102 may be operated by an independent service provider to obtain, store, and use corresponding data associated with each agriculture business to perform analysis and related tasks for each business. For example, the TOC analysis platform 102 may generate and use the corresponding TOC chained operation record ledger for each agriculture business during the performance of such tasks for each business.

### Example TOC Analysis Platform Components

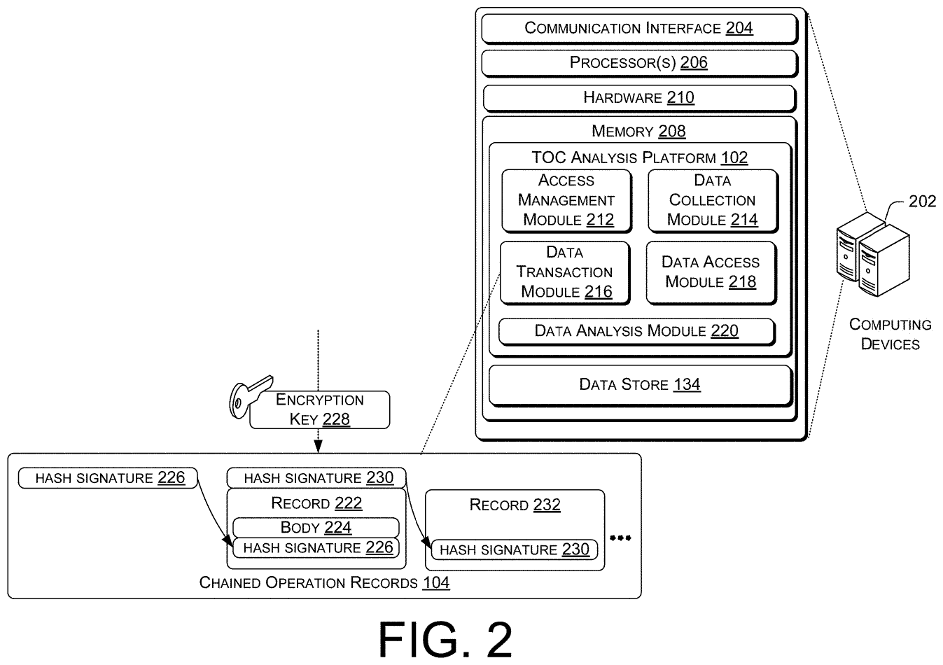

FIG. 2 is a block diagram showing various components of one or more illustrative computing nodes that enable the use of the TOC analysis platform that provides electric TOC recording keeping and analysis. The TOC analysis platform 102 may be implemented by one or more computing devices 202. The computing devices 202 may include a communication interface 204, one or more processors 206, and memory 208. The communication interface 204 may include wireless and/or wired communication components that enable the computing devices 202 to transmit data to and receive data from other networked devices. The computing devices 202 may be accessed via hardware 210. The hardware 210 may include additional user interfaces, data communication, or data storage hardware. For example, the user interface may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 208 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The TOC analysis platform 102 may be stored in the memory 208. The TOC analysis platform 102 may include an access management module 212, a data collection module 214, a data transaction module 216, a data access module 218, and a data analysis module 220. The modules may include routines, program instructions, objects, and/or data structures that perform particular tasks or implement particular abstract data types. The memory 208 may be further configured to implement a data store 134.

The access management module 212 may enable users, such as the user 120, to authenticate to the TOC analysis platform 102 via a user application (e.g., the user application 118). For example, the user 120 may have originally established a corresponding user account by providing registration information to the access management module 212 in order to establish the user account. The registration information may include a user name, a user address, user contact information, and/or so forth. In turn, the access management module may assign authentication credentials (e.g., a login name, a password, etc.) for accessing the user account. Accordingly, a user may gain access to the various functions performed by the TOC analysis platform 102 using the corresponding authentication credentials.

Additionally, the access management module 212 may be responsible for managing third-party access to the TOC analysis platform 102 and/or the TOC chained operation record ledger 104 for the retrieval of operation records. Accordingly, the access management module 212 may enable third-party entities, such as certification authorities, to create entity accounts that are stored in the data store 134. A third-party entity may establish a corresponding entity account by providing registration information to the access management module 212 via a user device. The registration information may include an entity name, an entity business address, entity contact information, authentication credentials (e.g., a login name, a password, etc.), and/or so forth. Accordingly, the access management module 212 may include a third-party entity authentication mechanism that validates third-party entities via corresponding authentication credentials for access to an online data retrieval portal associated with the TOC analysis platform 102.

The data collection module 214 may include a workflow scheduler that periodically checks for and retrieves newly available data from various databases associated with the agriculture business 106, such as the third-party databases 110 and the internal databases 112. The workflow scheduler may handle the extraction and the retrieval of the data based on configurable policies inputted via a user application, such as the user application 118. For example, a configurable policy may specify the source data location, frequency of data retrieval, handling procedures for late arrival data, data retention period, and data disposal following an expiration of the data retention period, and/or so forth. The handling procedures for the late arrival data may specify a predetermined cutoff period during which any data arriving late may be incorporated with data that is retrieved on time for processing.

In various embodiments, the data collection module 214 may employ file transfer protocol (FTP), Hypertext Transfer Protocol (HTTP) posts, direct network infrastructure element connection, and/or other data transfer techniques to obtain data from the databases. In some instances, the data collection module 214 may use data adaptors to interface with the databases. Additionally, the data collection module 214 may use various encrypted communication techniques to exchange data with the databases. For example, the data collection module 214 may use an asymmetric or symmetric encryption algorithm to secure the data during transport. Thus, the data collection module 214 may be used to obtain operation records related to the use of electric tractors and the use of fossil fuel tractors from various databases.

The data transaction module 216 may use predefined data conversion and/or data formatting logics to convert the data received from various data sources and/or inputted via a user application into operation records. For example, the operation record for a received government subsidy may include record data such as the date that the subsidy is received, an amount of the subsidy received, the identification information of the government agency that provided the subsidy, a state purpose or qualification for the subsidy, a method of payment, a unique record identifier assigned to the transaction, and/or so forth. In another example, the operation record for an expense may include record data such as the date of the expense, an amount of the expense, a stated purpose of the expense, identification information of the party to which the expense is paid, a method of payment, a unique record identifier assigned to the transaction, and/or so forth. Each operation record is stored by the data transaction module 216 in the TOC chained operation record ledger 104. During the storage of an operation record in the TOC chained operation record ledger 104 by the data transaction module 216, the record data in the operation record may be encrypted using a unique encryption key. If the operation record is a first operation record to be added to the TOC chained operation record ledger 104, the data transaction module 216 may store an initial (e.g., random) signature value in the body of the operation record. However, if the access configuration record is any subsequent operation record, the data transaction module 216 may store a unique cryptographic hash signature of a prior operation record of the TOC chained operation record ledger 104 in the body of the operation record. Subsequently, the data transaction module 216 may direct a cryptographic hash signature to be generated for the operation record using a hashing algorithm. The operation record is then added to the TOC chained operation record ledger 104. In this way, the cryptographic hash signature of the operation record may be appended to a subsequent operation record to create a series of linked operation records. In some embodiments, the data transaction module 216 may perform such operations for a standalone ledger. Alternatively, the data transaction module 216 may use a third-party blockchain or distributed ledger service to perform the operations related to storing the operation record into a blockchain ledger or some other distributed ledger.

Thus, as an example illustration, an operation record 222 of the TOC chained operation record ledger 104 may contain a body 224 that stores data, such as data related to the operation of a fleet of electric tractors. The record may further store a cryptographic hash signature 226. If the operation record 222 is the first record in the TOC chained operation record ledger 104, the cryptographic hash signature 226 may be an initial signature value that is generated for the TOC chained operation record ledger 104. However, if the operation record 222 is any subsequent operation record, the cryptographic hash signature 226 may be a hash value of a prior record in the TOC chained operation record ledger 104. In this way, the operation record 222 may be linked to the prior record of the blockchain ledger. In various embodiments, the cryptographic hash signature 230 may be created by calculating a hash of the data contained in the operation record 222 (e.g., the body 224, the cryptographic hash signature 226, etc.) via a hashing algorithm (e.g., HMAC, SHA256, RSASSA-PSS, etc.), and then encrypting the hash with an encryption key 228, such as the encryption key of the TOC analysis platform 102, to generate the cryptographic hash signature 230. The cryptographic hash signature 230 may be stored into a subsequent record 232 to link the operation record 222 with the subsequent record 232, with a further hash signature further generated for the subsequent record 232 for further linking of records in a similar manner.

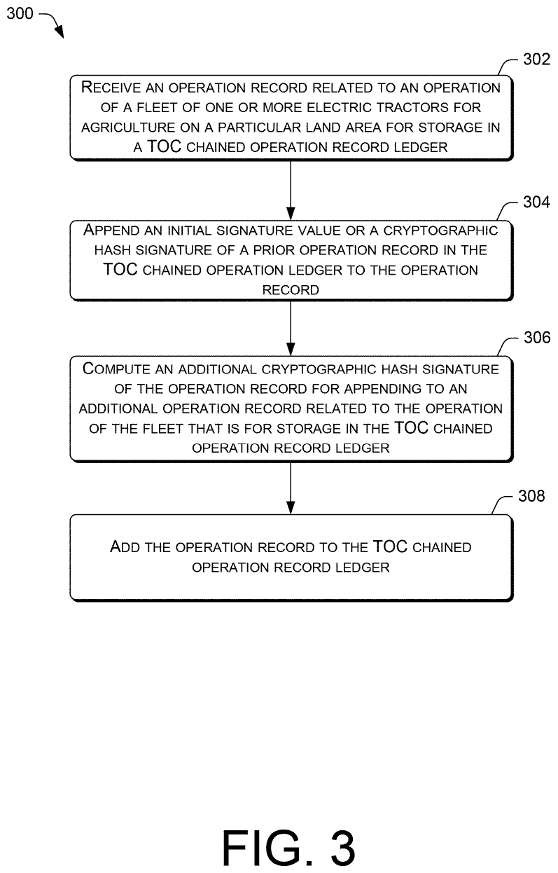

Furthermore, in some embodiments, operation records may be stored in a duplicative and distributed manner across multiple computing nodes according to blockchain principles, in which the computing nodes may be located at disparate geolocations. In such embodiments, the data transaction module 216 may make use of a blockchain algorithm that is configured to accomplish such a task as well as retrieve data from the operation records. Further, the TOC chained operation record ledger 104 may be one of multiple copies of a distributed ledger that is stored on a plurality of computer nodes. Accordingly, the depictions of the TOC chained operation record ledger 104 in FIG. 1 and FIG. 3 are illustrative rather than limiting. The use of blockchain principles means that it is not possible to retroactively alter the records stored in any particular blockchain ledger without altering all subsequent blocks with the cooperation of a majority of the computing nodes in a distributed computing network. As a result, blockchain technology provides a decentralized secure data storage for storing records in a verifiable and permanent manner.

The data access module 218 may receive requests from computing devices of third-party entities to access the TOC chained operation record ledger 104 via the online data retrieval portal. The online data retrieval portal may be provided by a web server or application server that interfaces with the data access module 218. The access management module 212 may be used by the data access module 218 to authenticate third-party entities. Accordingly, the data access module 218 may provide the third-party with access to the TOC chained operation record ledger 104. In some instances, a third-party may be a certification authority that grants a certification status to the agriculture business 106 based on the data in the TOC chained operation record ledger 104. For example, the certification authority may grant the agriculture business 106 that operates a farm a sustainable farming status when the agriculture business 106 uses only electric tractors for its agriculture operations on the farm for a predetermined period of time. In another example, the certification authority may grant the agriculture business 106 that operates a farm a reduced carbon emission status when the agriculture business 106 uses only electric tractors for its agriculture operations on the farm, as well as self generates sufficient electricity from a renewable source to provide for use by all other electrical needs of the farm, for a predetermined period of time.

In other instances, the data access module 218 may also receive data access requests pertaining to the TOC chained operation record ledger 104 from user devices of users via an online query portal. The online query portal may be provided by a web server or application server that interfaces with the data access module 218. The online query portal may permit a user to submit the query after the authentication credentials of the user are validated by the access management module 212. A data access query submitted by a user device of a user may include a user identifier of the user. The data access query may further include one or more query parameters, such as the time period to be queried, the type of data to be queried, and/or so forth. Accordingly, the data access module 218 may retrieve data that matches the data access query 140 from the TOC chained operation record ledger 104. Subsequently, the data access module 218 may return the requested data to the user device for presentation by a user application. Additionally, the data access module 218 may receive data access requests to access data stored in the TOC chained operation record ledger from the data analysis module 220.

The data analysis module 220 may use the data stored in the TOC chained operation record ledger 104 and the data store 134 to perform financial analysis that compares the costs of using electric tractors versus fossil fuel tractors for an agriculture business, such as the agriculture business 106. In some embodiments, data analysis module 220 may receive input of one or more initial costs associated with operating a fleet of one or more electric tractors for agriculture on a particular plot of land. The initial costs may include the capital cost of purchasing the fleet of electric tractors, purchasing and setting up the electrical charging infrastructure to support the electric tractors, cost of training employees to use the electric tractors, purchasing and setting up onsite green electricity generation equipment (e.g., solar panels, wind turbines, etc.) to provide electricity for the electric tractors, and/or so forth. The data analysis module 220 may further receive inputs of expenses and credits associated with operating the fleet of one or more electric tractors over a period of time for a particular land area. The expenses may include costs such as electrical utility costs, tractor maintenance costs, labor costs, administrative costs, and/or so forth. The credits may include one-time or ongoing government and/or private subsidies and grants that are offered to agricultural operations that partially or exclusively use electric tractors. Subsequently, the data analysis module 220 may calculate a total operational expense for using the fleet of one or more electric tractors for the period of time. For example, the costs of using the fleet of one or more electric tractors may be partially offset by the credits received for using the fleet. The total operational expense may be further compared by the data analysis module 220 to the historical expense or an estimated expense for operating a comparable fleet of one or more fossil fuel tractors during a similar time interval on a comparable land area.

The historical expense may be an expense that the agriculture business has previously incurred or an expense that another agriculture business incurred while operating a comparable fleet of one or more fossil fuel tractors during a similar time interval on a comparable land area. For example, the data analysis module 220 may have access to a store of such historical information that is obtained from one or more databases, in which the use of an expense that another agriculture business incurred is with the permission of that business. The estimated expense may be a value that the data analysis module 220 estimates based on one or more known values. These known values may include supply chain costs, fuel chain costs, maintenance costs, insurance costs, labor costs, health and safety costs, and/or so forth for operating the fossil fuel tractors. For example, a known value may be an average industry or business sector value for operating a particular number of fossil tractors for a time period for a particular land area for agriculture. Accordingly, the data analysis module 220 may then extrapolate an expense based on the known value for a number of fossil tractors that match the number of electric tractors operated by the agriculture business, and also for a time period and a land area that are directly comparable to the values associated with the operation of the electric tractors by the agriculture business. In this way, the data analysis module 220 may compare the total operational expense to the historical or predicted expense to determine cost savings for using the fleet of electric tractors instead of the fleet of fossil fuel tractors.

In other embodiments, in addition to using past expenses and credits to calculate the costing savings associated with using a fleet of one or more electric tractors, the data analysis module 220 may also additionally predict future expenses and credits in order to provide forecasted cost savings. In such embodiments, the data analysis module 220 may use various algorithms to predict future expenses or credits for operating the fleet of electric tractors. In some instances, the algorithm may be a quotative forecasting algorithm (e.g., an average approach algorithm, a naive approach algorithm, a drift method algorithm) that predicts future values based on historical values. In other instances, the algorithm may use a machine-learning algorithm to predict future expenses or credits for operating the fleet of electric tractors.

The machine-learning model may be trained via a model training algorithm. The model training algorithm may implement a training data input phase, a feature engineering phase, and a model generation phase. In the training data input phase, the model training algorithm may receive training data. For example, each of the individual training datasets in the training data may include costs associated with operating electric tractors, such as purchase costs, maintenance costs, repair costs, fossil fuel costs, electricity costs, and/or so forth for multiple periods of time. The training data may also include associated external data for the multiple periods of time, such as weather data, temperature data, prices of various parts, services, and equipment (e.g., charging stations, solar panels, wind turbines, etc.) that support the operation of fossil fuel and electric tractors. The training data may include data that are obtained from various publicly available databases as well as data that are obtained from various agriculture businesses with their consent.

During the feature engineering phase, the model training algorithm may pinpoint features in the training data. Accordingly, feature engineering may be used by the model training algorithm to figure out the significant properties and relationships of the input datasets that aid a machine-learning model to distinguish between different classes of data. During the model generation phase, the model training algorithm may select an initial type of machine-learning algorithm to train a machine-learning model using the training data. Following the application of a selected machine-learning algorithm to the training data, the model training algorithm may determine a training error measurement of the machine-learning model. If the training error measurement exceeds a training error threshold, the model training algorithm may use a rule engine to select a different type of machine-learning algorithm based on a magnitude of the training error measurement. The different types of machine-learning algorithms may include a Bayesian algorithm, a decision tree algorithm, a support vector machine (SVM) algorithm, an ensemble of trees algorithm (e.g., random forests and gradient-boosted trees), an artificial neural network, and/or so forth. The training process is generally repeated until the training results fall below the training error threshold and the trained machine-learning model is generated.

Thus, the data analysis module 220 may use one or more trained machine-learning models to predict future expenses and future credits associated with operating the fleet of one or more electric tractors for a future period of time. The use of the trained-learning models may enable the data analysis module 220 to take into consideration the long-term impact of certain factors or trends that affect costs or credits in the future period of time. For example, seasonal temperature changes or weather patterns may affect the efficiency of electric tractors or the ability to generate electricity from on-site solar panels or wind turbines. In another example, technical advances in battery or solar panels may increase the efficiency of such technology and lower the cost of operating a fleet of electric tractors over a period of time. Accordingly, the data analysis module 220 may use the predicted future expenses and credits concurrently with the past expense and credits of the agriculture business to determine cost savings associated with operating a fleet of one or more electric tractors.

In additional embodiments, the data analysis module 220 may use an initial investment calculation algorithm to calculate an initial investment that an agriculture business needs to make in order to convert from using a fleet of one or more fossil fuel tractors to using a similar fleet of one or more electric tractors. In at least one embodiment, the initial investment calculation may generate an amount that is the sum of capital expenditure, any change in working capital, and a net cash flow from the disposal of assets. For example, the capital expenditure may include funds needed to purchase a selected number of electric tractors, support equipment (e.g., electrical charging stations, battery chargers, swappable electrical batteries, etc.), electricity generation equipment (e.g., solar panels, wind turbines, etc.), and/or so forth. The change in working capital may be the change in the financial balance of the agriculture business as a result of the switch over, taking into account cost savings and efficiencies provided by the use of the fleet of one or more electric tractors. The net cash flow from the disposal of assets may be any funds generated from the sale of the existing fleet of fossil fuel tractors.

In various embodiments, the data analysis module 220 may perform the analyses and calculations based on user-inputted parameters. For example, the parameters may be inputted by a user via an application user interface of a user application, such as the user application 118. Likewise, the results of the analyses and calculations may be provided by the data analysis module 220 to the application user interface for presentation to a user. The parameter for an analysis to be performed by the data analysis module 220 may include a number of electric tractors, a time interval for which the analysis are to be performed, the sources of data to be used for the analysis, the type of analysis or calculation to be performed, the types of algorithms to be used for the analysis, and/or so forth. The results of the analyses and calculations performed by the data analysis module 220 may be stored in the data store 134. Additional details regarding the analyses and calculations performed by the data analysis module 220 are further described below with respect to FIGS. 3-6.

### Example Processes

FIGS. 3-7 present illustrative processes 300-700 that are used by a TOC analysis platform to store and analyze operation records related to the use of electric tractors by an agriculture business. Each of the processes 300-700 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300-700 are described with reference to the architecture 100 of FIG. 1.

FIG. 3 is a flow diagram of an example process 300 for appending an electric tractor operation record to a TOC chained operation record ledger. At block 302, the TOC analysis platform 102 may receive an operation record related to an operation of a fleet of one or more electric tractors for agriculture on a particular land area for storage in a TOC chained operation record ledger. At block 304, the TOC analysis platform 102 may append an initial signature value or a cryptographic signature of a prior operation record in the TOC chained operation ledger to the operation record. The initial signature value may be any unique (e.g., random) value that is generated by the TOC analysis platform 102.

At block 306, the TOC analysis platform 102 may compute an additional cryptographic hash signature of the operation record for appending to an additional operation record related to the operation of the fleet that is for storage in the TOC chained operation record ledger. In various embodiments, the cryptographic hash signature may be generated by hashing the data contained in the operation record with a cryptographic hashing algorithm, such as e.g., HMAC, SHA256, RSASSA-PSS, etc. At block 308, the TOC analysis platform 102 may add the operation record to the TOC chained operation record ledger. In various embodiments, the TOC chained operation record ledger may be a blockchain ledger, a comparable distributed ledger, or a non-distributed standalone ledger.

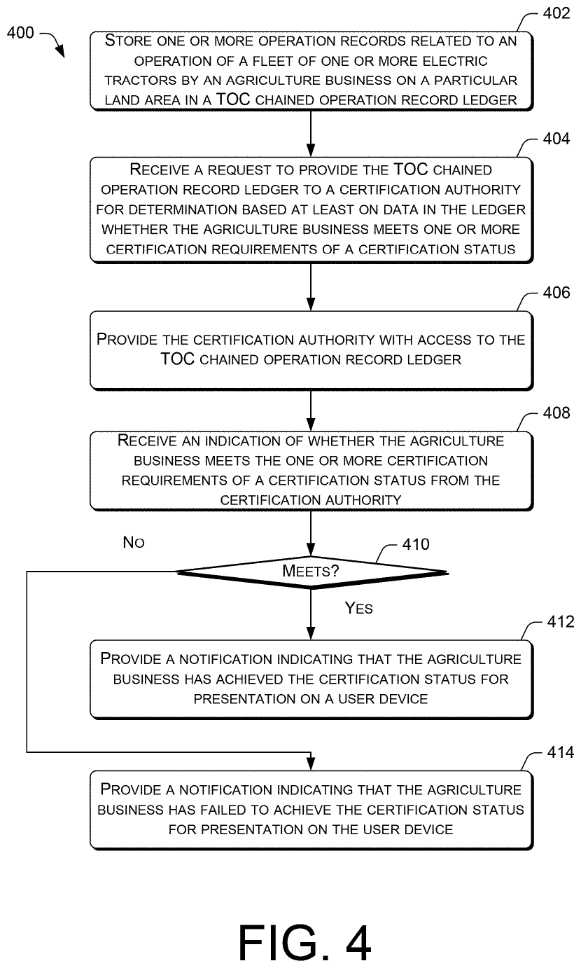

FIG. 4 is a flow diagram of an example process 400 for obtaining a certification status from a certification authority for an agriculture business based on data in the TOC chained operation record ledger. At block 402, the TOC analysis platform 102 may store one or more operation records related to an operation of a fleet of one or more electric tractors for agriculture on a particular land area in a TOC chained operation record ledger. In various embodiments, the chained operation record ledger may be a blockchain ledger, a comparable distributed ledger, or a non-distributed standalone ledger that is configured to securely store information in a way that prevents tampering or modification of the information stored in the ledger subsequent to the storage of the information in the ledger.

At block 404, the TOC analysis platform 102 may receive a request to provide the TOC chained operation record ledger to a certification authority for determination based at least on data in the ledger whether the agriculture business meets one or more certification requirements of a certification status. In various embodiments, the TOC analysis platform 102 may receive the request from a certification verification application of the certification authority after submitting an initial request to the certification verification application. The initial request may be a request for the certification authority to grant the agriculture business the certification status.

At block 406, the TOC analysis platform 102 may provide the certification authority with access to the TOC chained operation record ledger. For example, the TOC analysis platform 102 may provide the certification verification application of the certification authority with access to APIs that can be called by the certification verification application to access the TOC chained operation record ledger.

At block 408, the TOC analysis platform 102 may receive an indication of whether the agriculture business meets the one or more certification requirements of a certification status from the certificate authority. In some instances, the certification verification application 126 may use pre-programmed logics to automatically review the operation record data in the operation records of the TOC chained operation record ledger. In other instances, the certification verification application may provide the operation record data as extracted from the TOC chained operation record ledger for manual review by an administrator of the certification authority.

At decision block 410, if the TOC analysis platform 102 receives an indication that the one or more certification requirements are met (“yes” at decision block 410), the process 400 may proceed to block 412. For example, following the automatic or review manual, the certification verification application may send a message to the TOC analysis platform 102 indicating that the agriculture business has achieved the certification status because the one or more certification requirements are met.

At block 412, the TOC analysis platform 102 may provide a notification indicating that the agriculture business has achieved the certification status for presentation on a user device. However, if the TOC analysis platform 102 receives an indication that the one or more certification requirements are not met (“no” at decision block 410), the process 400 may proceed to block 414. For example, following the automatic or review manual, the certification verification application may send a message to the TOC analysis platform 102 indicating that the agriculture business has failed to achieve the certification status because at least one of the one or more certification requirements is not met. At block 414, the TOC analysis platform 102 may provide a notification indicating that the agriculture business has failed to achieve the certification status for presentation on the user device.

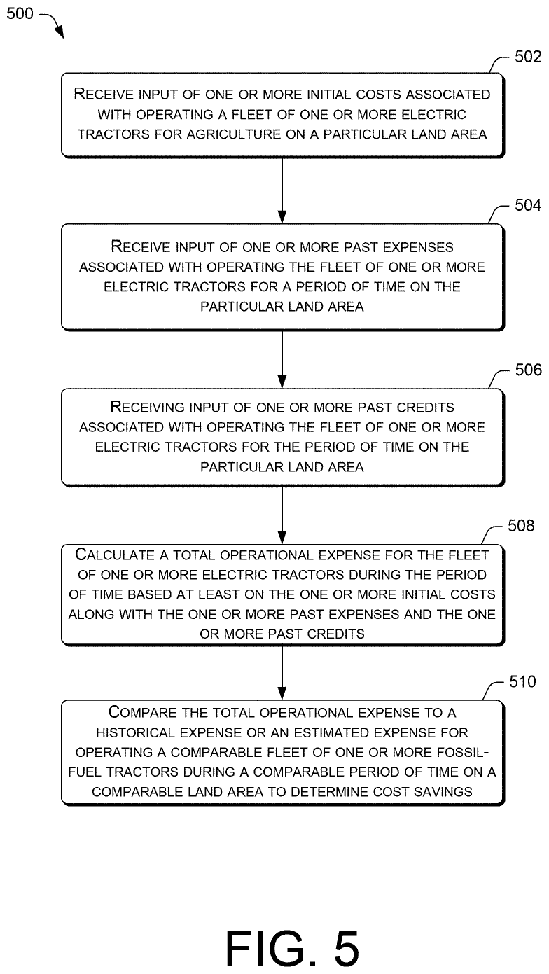

FIG. 5 is a flow diagram of an example process 500 for comparing a total operational expense for a fleet of one or more electric tractors operated by an agriculture business to an operational expense for a comparable fleet of one or more fossil fuel tractors. At block 502, the TOC analysis platform 102 may receive input of one or more initial costs associated with operating a fleet of one or more electric tractors for agriculture on a particular land area. For example, the initial costs may include the capital cost of purchasing the fleet of electric tractors, purchasing and setting up the electrical charging infrastructure to support the electric tractors, cost of training employees to use the electric tractors, purchasing and setting up onsite green electricity generation equipment (e.g., solar panels, wind turbines, etc.) to provide electricity for the electric tractors, and/or so forth.

At block 504, the TOC analysis platform 102 may receive an input of one or more past expenses associated with operating the fleet of one or more electric tractors for a period of time on the particular land area. For example, the one or more past expenses may include one-time and/or recurring expenses, such as electricity costs, vehicle maintenance costs, labor costs, insurance costs, health and safety costs, and/or so forth associated with using the fleet of one or more electric tractors.

At block 506, the TOC analysis platform 102 may receive input of one or more past credits associated with operating the fleet of one or more electric tractors for the period of time on the particular land area. The credits may include governmental and/or private credits that can be used to offset the costs associated with using the fleet of electric tractors. For example, the credits may include one-time or ongoing government and/or private subsidies and grants that are offered to agricultural operations that partially or exclusively use electric tractors.

At block 508, the TOC analysis platform 102 may calculate a total operational expense for the fleet of one or more electric tractors during the period of time based at least on the one or more initial costs along with the one or more past expenses and the one or more past credits. For example, the one or more initial costs and the amount of expenses may be added together and then offset by the amount of credits to calculate the total operational expense. However, in alternative embodiments, the total operational expense may be calculated by offsetting the amount of expenses by the amounts of credits without taking into consideration the one or more initial costs.

At block 510, the TOC analysis platform 102 may compare the total operational expense to a historical expense or an estimated expense for operating a comparable fleet of one or more fossil-fuel tractors during a comparable period of time on a comparable land area to determine cost savings. The historical expense or the estimated expense may be an expense that is incurred by the agriculture business, by another agriculture business, or may be an average industry or business sector value calculated for the comparable fleet of one or more fossil-fuel tractors. In instances in which the total operational expense as calculated includes the one or more initial costs, the historical expense or an estimated expense may also include the one or more initial costs associated with operating the comparable fleet of one or more fossil fuel vehicles. Otherwise, the one or more initial costs associated with operating the comparable fleet of one or more fossil fuel vehicles are not included in the historical expense or an estimated expense.

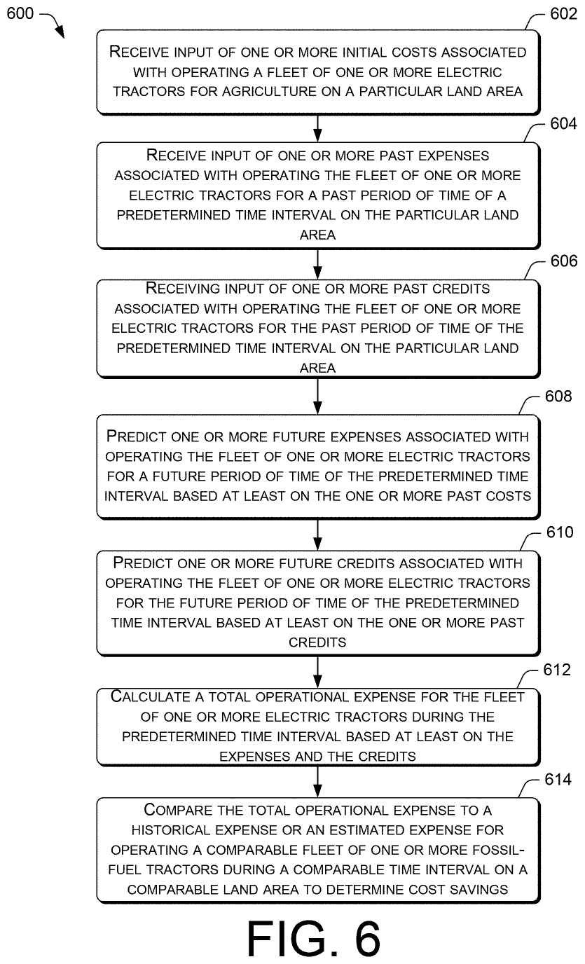

FIG. 6 is a flow diagram of an alternative example process 600 for comparing a total operational expense for a fleet of one or more electric tractors operated by an agriculture business to an operational expense for a comparable fleet of one or more fossil fuel tractors. At block 602, the TOC analysis platform 102 may receive input of one or more initial costs associated with operating a fleet of one or more electric tractors for agriculture on a particular land area. For example, the initial costs may include the capital cost of purchasing the fleet of electric tractors, purchasing and setting up the electrical charging infrastructure to support the electric tractors, cost of training employees to use the electric tractors, purchasing and setting up onsite green electricity generation equipment (e.g., solar panels, wind turbines, etc.) to provide electricity for the electric tractors, and/or so forth.

At block 604, the TOC analysis platform 102 may receive an input of one or more past expenses associated with operating the fleet of one or more electric tractors for a past period of time of a predetermined time interval on the particular land area. For example, the one or more past expenses may include one-time and/or recurring expenses, such as electricity costs, vehicle maintenance costs, labor costs, insurance costs, health and safety costs, and/or so forth associated with using the fleet of one or more electric tractors.

At block 606, the TOC analysis platform 102 may receive input of one or more past credits associated with operating the fleet of one or more electric tractors for the past period of time of the predetermined time interval on the particular land area. The credits may include governmental and/or private credits that can be used to offset the costs associated with using the fleet of electric tractors. For example, the credits may include one-time or ongoing government and/or private subsidies and grants that are offered to agricultural operations that partially or exclusively use electric tractors.

At block 608, the TOC analysis platform 102 may predict one or more future expenses associated with operating the fleet of one or more electric tractors for a future period of time of the predetermined time interval based at least on the past costs. For example, the future expenses may be extrapolated based on the one or more past costs. In some embodiments, the one or more future expenses may be predicted based at least on the past costs and one or more external factors. For example, these factors may include seasonal temperature changes or weather patterns that may affect the efficiency of electric tractors or the ability to generate electricity from on-site solar panels or wind turbines. In such embodiments, a machine-learning algorithm may be used to account for variabilities and trends to predict the future expenses.

At block 610, the TOC analysis platform 102 may predict one or more future credits associated with operating the fleet of one or more electric tractors for the future period of time of the predetermined time interval based at least on the one or more past credits. For example, the future credits may be extrapolated based on the past credits. In some embodiments, the one or more future credits may be predicted based at least on the past costs and one or more external factors. For example, these factors may include technical advances in battery or solar panels that increase the efficiency of such technology and lower the cost of operating a fleet of electric tractors over a period of time. In such embodiments, a machine-learning algorithm may be used to account for variabilities and trends to predict the future credits.

At block 612, the TOC analysis platform 102 may calculate a total operational expense for the fleet of one or more electric tractors during the predetermined time interval based at least on the expenses and credits. For example, the one or more initial costs, the amount of past expenses, the amount of future expenses may be added together and then offset by the amount of past credits and the amount of future credits to calculate the total operational expense. However, in alternative embodiments, the total operational expense may be calculated by offsetting the amount of expenses by the amounts of credits without taking into consideration the one or more initial costs.

At block 614, the TOC analysis platform 102 may compare the total operational expense to a historical expense or an estimated expense for operating a comparable fleet of one or more fossil-fuel tractors during a comparable time interval on a comparable land area to determine cost savings. The historical expense or the estimated expense may be an expense that is incurred by the agriculture business, by another agriculture business, or may be an average industry or business sector value calculated for the comparable fleet of one or more fossil-fuel tractors. In instances in which the total operational expense as calculated includes the one or more initial costs, the historical expense or an estimated expense may also include the one or more initial costs associated with operating the comparable fleet of one or more fossil fuel vehicles. Otherwise, the one or more initial costs associated with operating the comparable fleet of one or more fossil fuel vehicles is not included in the historical expense or an estimated expense.

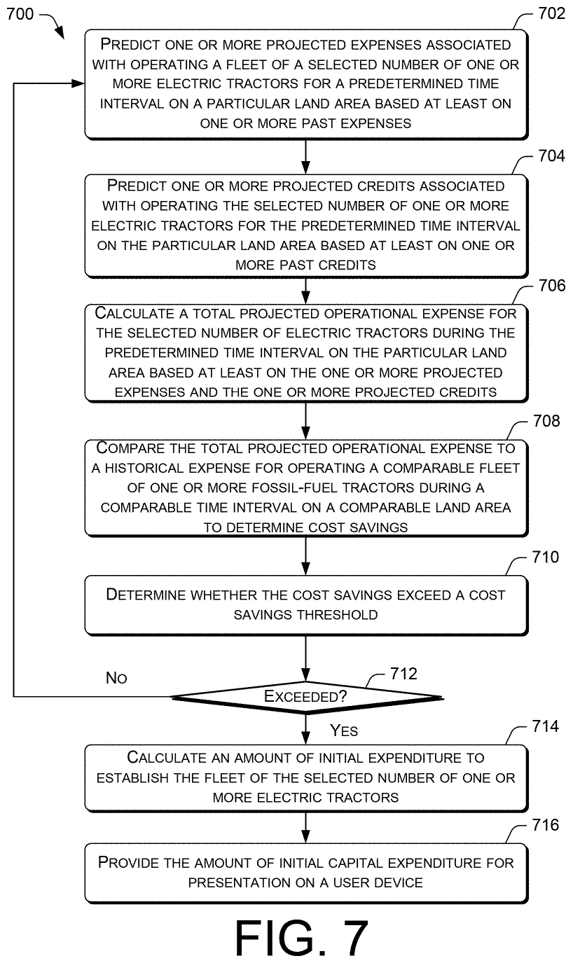

FIG. 7 is a flow diagram of an example process 700 for estimating an amount of initial capital expenditure for converting an agriculture business from using a fleet of one or more fossil fuel tractors to using a fleet of electric tractors. At 702, the TOC analysis platform 102 may predict one or more projected expenses with operating a fleet of a selected number of one or more electric tractors for a predetermined time interval on a particular land area based at least on one or more past expenses. The past expenses may be expenses that have been previously incurred for operating at least one electric tractor that is further extrapolated or used for the selected number of one or more electric tractors. The past expenses may be an expense that is incurred by the agriculture business, by another agriculture business, or may be an average industry or business sector value.

At block 704, the TOC analysis platform 102 may predict one or more projected credits associated with operating the selected number of one or more electric tractors for the predetermined time interval on the particular land area based at least on the one or more past credits. The past credits may be credits that have been previously received for operating at least one electric tractor that is further extrapolated or used for the selected number of one or more electric tractors. The past expenses may be an expense that is received by the agriculture business, by another agriculture business, or may be an average industry or business sector value.

At block 706, the TOC analysis platform 102 may calculate a total projected operational expense for the selected number of electric tractors during the predetermined time interval based at least on the one or more projected expenses and the one or more projected credits. For example, the amount of expenses may be offset by the amount of credits to calculate the total projected operational expense.

At block 708, the TOC analysis platform 102 may compare the total projected operational expense to a historical expense for operating a comparable fleet of one or more fossil-fuel tractors during a comparable time interval on a comparable land area to determine cost savings. At block 710, the TOC analysis platform 102 may determine whether the cost savings exceed a cost savings threshold. At decision block 712, if the TOC analysis platform 102 determines that the cost savings exceed the cost saving threshold (“yes” at decision block 712), the process 700 may proceed to block 714.

At block 714, the TOC analysis platform 102 may calculate an amount of initial expenditure to establish the fleet based at least on the selected number of one or more electric tractors. For example, initial expenditure may be calculated based on the cost of purchasing the fleet of the selected number of electric tractors, purchasing and setting up the electrical charging infrastructure to support the selected number of electric tractors, cost of training employees to use the selected number of electric tractors, purchasing and setting up onsite green electricity generation equipment (e.g., solar panels, wind turbines, etc.) to provide electricity for the selected number of electric tractors, and/or so forth.

At block 716, the TOC analysis platform 102 may provide the amount of initial capital expenditure for presentation on a user device. However, if the TOC analysis platform 102 determines that the cost savings do not exceed the cost saving threshold (“no” at decision block 712), the process 700 may loop back to block 702. In this way, a user may use the TOC analysis platform 102 to select a new number of electric tractors and use the process 700 to determine whether operating the new number of electric tractors provides sufficient cost savings.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
storing one or more operation records related to an operation of a fleet of one or more electric tractors by an agriculture business on a particular land area in a chained operation record ledger;
providing a certification authority with access to the chained operation record ledger for the certification authority to determine based at least on data in the chained operation record ledger whether the agriculture business meets one or more certification requirements of a certification status;
in response to the certification authority determining that the agriculture business has met one or more certification requirements of the certification status, providing a first notification indicating that the agriculture business has achieved the certification status for presentation on a user device of the agriculture business; and
in response to the certification authority determining that the agriculture business has not met one or more certification requirements of the certification status, providing a second notification indicating that the agriculture business failed to achieve the certification status for presentation on the user device of the agriculture business.

2. The one or more non-transitory computer-readable media of claim 1, wherein the storing includes:
receiving an operation record related to an operation of the fleet of one or more electric tractors for agriculture on a particular land area for storage in the chained operation record ledger;
appending an initial signature value or a cryptographic hash signature of a prior operation record in the chained operation record ledger to the operation record;
computing an additional cryptographic hash signature of the operation for appending to an additional operation record related to the operation of the fleet that is for storage in the chained operation record ledger; and
adding the operation record to the chained operation record ledger.

3. The one or more non-transitory computer-readable media of claim 1, wherein the certification authority is a government agency or a private organization.

4. The one or more non-transitory computer-readable media of claim 1, wherein the certification status is a prerequisite to receiving a subsidy, a grant, or a business purchase from a government entity or a private business.

5. The one or more non-transitory computer-readable media of claim 1, wherein the certification status includes a sustainable farming status, a reduced carbon emission status, or a zero-carbon emission status.

6. The one or more non-transitory computer-readable media of claim 1, wherein the chained operation record ledger is a blockchain ledger or a non-distributed standalone ledger.

7. The one or more non-transitory computer-readable media of claim 1, wherein the acts further comprise:
receiving input of one or more past expenses associated with operating a fleet of one or more electric tractors for a period of time on a particular land area;
receiving input of one or more past credits associated with operating the fleet of one or more electric tractors for the period of time on the particular land area;
calculating a total operational expense for the fleet of one or more electric tractors during the period of time based at least on the one or more past expenses and the one or more past credits; and
comparing the total operational expense to a historical expense or an estimated expense for operating a comparable fleet of one or more fossil-fuel tractors during a comparable period of time on a comparable land area to determine cost savings.

8. The one or more non-transitory computer-readable media of claim 7, further comprising receiving input of one or more initial costs associated with operating the fleet of one or more electric tractors for agriculture on the particular land area, wherein the calculating includes calculating the total operational expense based on the one or more initial costs, the one or more past expenses and the one or more past credits, and wherein the historical expense or the estimated expense includes one or more additional initial costs associated with operating the comparable fleet of one or more fossil-fuel tractors.

9. The one or more non-transitory computer-readable media of claim 8, wherein the receiving includes receiving at least one operation record related to the initial costs, the one or more past expenses, or the one or more past credits from the chained operation record ledger.

10. The one or more non-transitory computer-readable media of claim 1, wherein the acts further comprise:
receiving input of one or more past expenses associated with operating a fleet of one or more electric tractors for a past period of time of a predetermined time interval on the particular land area;
receiving input of one or more past credits associated with operating the fleet of one or more electric tractors for the past period of time of the predetermined time interval on the particular land area;
predicting one or more future expenses associated with operating the fleet of one or more electric tractors for a future period of time of the predetermined time interval based at least on the one or more past costs;
predicting one or more future credits associated with the operating the fleet of one or more electric tractors for the future period of time of the predetermined time interval based at least one the one or more past credits;
calculating a total operational expense for the fleet of one or more electric tractors during the predetermined time interval based at least on the one or more past expenses, the one or more future expenses, the one or more past credits, and the one or more future credits; and
comparing the total operational expense to a historical expense or an estimated expense for operating a comparable fleet of one or more fossil-fuel tractors during a comparable period of time on a comparable land area to determine cost savings.

11. The one or more non-transitory computer-readable media of claim 10, wherein the predicting includes predicting the one or more future expenses based on the one or more past costs and one or more external factors via a machine-learning algorithm, and wherein the predicting includes predicting the one or more future credits based on the one or more past credits and one or more external factors via a machine-learning algorithm.

12. The one or more non-transitory computer-readable media of claim 10, wherein the acts further comprise receiving input of one or more initial costs associated with operating the fleet of one or more electric tractors for agriculture on a particular land area, wherein the calculating includes calculating the total operational expense based on the one or more initial costs, the one or more past expenses, the one or more future expenses, the one or more past credits, and the one or more future credits, and wherein the historical expense or the estimated expense includes one or more additional initial costs associated with operating the comparable fleet of one or more fossil-fuel tractors.

13. The one or more non-transitory computer-readable media of claim 12, wherein the receiving includes receiving at least one operation record related to the initial costs, the one or more past expenses, or the one or more past credits from the chained operation record ledger.

14. The one or more non-transitory computer-readable media of claim 1, wherein the acts further comprise:
predicting one or more projected expenses associated with operating a fleet of a selected number of one or more electric tractors for a predetermined time interval on a particular land area based at least on past expenses;
predicting one or more projected credits associated with operating the selected number of one or more electric tractors for the predetermined time interval on the particular land area based at least one or more past credits;
calculating a total projected operational expense for the selected number of electric tractors during the predetermined time interval on the particular land area based at least on the one or more projected expenses and the one or more projected credits;
comparing the total projected operation expense to a historical expense for operating a comparable fleet of one or more fossil-fuel tractors during a comparable time interval on a comparable land area to determine cost savings; and
in response to the costing savings exceeding a cost savings threshold, calculating an amount of initial expenditure to establish the fleet of the selected number of one or more electric tractors.

15. One or more computing devices, comprising:
one or more processors; and
memory including a plurality of computer-executable components that are executable by the one or more processors to perform a plurality of actions, the plurality of actions comprising:
storing one or more operation records related to an operation of a fleet of one or more electric tractors by an agriculture business on a particular land area in a chained operation record ledger;
providing a certification authority with access to the chained operation record ledger for the certification authority to determine based at least on data in the chained operation record ledger whether the agriculture business meets one or more certification requirements of a certification status;
in response to the certification authority determining that the agriculture business has met one or more certification requirements of the certification status, providing a first notification indicating that the agriculture business has achieved the certification status for presentation on a user device of the agriculture business; and
in response to the certification authority determining that the agriculture business has not met one or more certification requirements of the certification status, providing a second notification indicating that the agriculture business failed to achieve the certification status for presentation on the user device of the agriculture business.

16. The one or more computing devices of claim 15, wherein the storing includes:
receiving an operation record related to an operation of the fleet of one or more electric tractors for agriculture on a particular land area for storage in the chained operation record ledger;
appending an initial signature value or a cryptographic hash signature of a prior operation record in the chained operation record ledger to the operation record;
computing an additional cryptographic hash signature of the operation for appending to an additional operation record related to the operation of the fleet that is for storage in the chained operation record ledger; and
adding the operation record to the chained operation record ledger.

17. The one or more computing devices of claim 15, wherein the certification authority is a government agency or a private organization, and wherein the certification status is a prerequisite to receiving a subsidy, a grant, or a business purchase from a government entity or a private business.

18. The one or more computing devices of claim 15, wherein the certification status includes a sustainable farming status, a reduced carbon emission status, or a zero-carbon emission status.

19. The one or more computing devices of claim 15, wherein the chained operation record ledger is a blockchain ledger or a non-distributed standalone ledger.

20. A computer-implemented method, comprising:
storing, via one or more computing devices, one or more operation records related to an operation of a fleet of one or more electric tractors by an agriculture business on a particular land area in a chained operation record ledger;
providing, via one or more computing devices, a certification authority with access to the chained operation record ledger for the certification authority to determine based at least on data in the chained operation record ledger whether the agriculture business meets one or more certification requirements of a certification status;
in response to the certification authority determining that the agriculture business has met one or more certification requirements of the certification status, providing a first notification indicating that the agriculture business has achieved the certification status for presentation on a user device of the agriculture business; and
in response to the certification authority determining that the agriculture business has not met one or more certification requirements of the certification status, providing a second notification indicating that the agriculture business failed to achieve the certification status for presentation on the user device of the agriculture business.
